(19) United States
(12) Patent Application Publication
(10) Pub. No.: US 2010/0268766 A1
(43) Pub. Date: Oct. 21, 2010

(54) DATA MANAGEMENT IN A GEOGRAPHICAL INFORMATION SYSTEM

(75) Inventors: Loïc Bouget, Rennes (FR); Christophe Floutier, Rennes (FR); Patrick Gioia, Servon Sur Vilaine (FR)

Correspondence Address: MCKENNA LONG & ALDRIDGE LLP, 1900 K STREET, NW, WASHINGTON, DC, 20006, US

(73) Assignee: FRANCE TELECOM, Paris (FR)

(21) Appl. No.: 12/750,148

(22) Filed: Mar. 30, 2010

(30) Foreign Application Priority Data
Mar. 31, 2009 (FR) 09-52066

(51) Int. Cl. G06F 15/16

(52) U.S. Cl. 709/203

(57) ABSTRACT

In a geographical information system, a spatial environment is represented according to representation data with reference to geographical areas. The geographical information system comprises a server and a terminal connected via a communication network. The server stores the representation data according to the geographical areas. A selection of a plurality of geographical areas is made at the level of the terminal, as a function of a criterion relating to a load level of the terminal. A request is sent from the terminal to the server indicating the selected plurality of geographical areas. The terminal receives the representation data according to a continuous transmission protocol.

This application claims priority to French Application Serial No. 09-52066, filed in France on Mar. 31, 2009, the contents of which is included herein by reference in its entirety.

The present invention relates to data management in a geographical information system and more particularly management of the transmission of this data type from a server to a client terminal.

A geographical information system makes it possible to propose a more or less realistic representation of a spatial environment on the basis of graphical primitives such as points, vectors, or also polygons. Thus, certain real spatial environments can be represented virtually based on representation data which are stored in a database. In such a system, representation data of the space considered are stored for example at the level of the server, and are transmitted to a client terminal of the server according to the needs of the application or applications implemented at the level of the terminal. In particular it can be envisaged in this context to offer a virtual navigation service in certain urban environments.

However, a terminal generally lacks the storage capacity to memorize the quantity of representation data necessary for a town in which the terminal user wishes to navigate virtually for example. Thus, the terminal generally receives only a part of the representation data corresponding to a part of the spatial environment, representing the town, within which the user wishes to navigate. Then, according to a virtual displacement within the town, it is convenient optionally to receive additional representation data needed by the terminal for the display. Management of the reception of representation data from the server at the level of the terminal is an important element supporting the performance of the service offered to the terminal user, such as a virtual navigation service for example.

Such data can be received from the server in a standard continuous transmission of the type known as ‘streaming’. However, this type of continuous transmission is unsuitable for the transmission of representation data. In fact, a streaming-type transmission is suitable for transmitting data which are indexed one-dimensionally only, such as data relating to standard multimedia content (such as audio or also audiovisual content) which are time-indexed only. A terminal wishing to receive data relating to standard multimedia content (for example, a video file, an audio file, etc.), can request the transmission of this content from the start or also by indicating a time reference for the server to transmit the multimedia content data, based on the time reference indicated by the terminal, in a linear and continuous fashion over time.

However, representation data used by a geographical information system are generally indexed two-dimensionally. In fact, these representation data depend on the location of a viewpoint within a virtual world, i.e. a representation of a spatial environment, in which the user wishes to navigate. This location can be determined in relation to a two-dimensional reference frame with respect to the ground of the virtual world considered. Thus, a streaming-type transmission cannot be applied so as to give good performance, since the representation data to be transmitted to the terminal depend on its current location and its displacement, which are indexed two-dimensionally. These representation data therefore cannot be transmitted linearly starting from a given location.

The purpose of the present invention is to improve the situation.

A first aspect of the present invention proposes a method for managing the reception of data in a geographical information system in which a spatial environment is represented according to representation data referring to geographical areas;

said geographical information system comprising a server and a terminal connected via a communication network;
the server storing the representation data according to geographical areas;
said method comprising the following steps carried out at the level of the terminal:

/a/ selecting a plurality of geographical areas as a function of a criterion relating to a load level of the terminal;

/b/ sending a request to the server indicating said selected plurality of geographical areas; and

/c/ receiving representation data according to a continuous transmission protocol.

By the term ‘geographical area’, is meant a geographical reference of the representation data. In an embodiment of the present invention, a two-dimensional image represents a ground projection of the spatial environment considered. This image is broken down into a plurality of geographical areas (or ‘patches’) which are used as a geographical reference of the spatial representation. In other words, the geographical areas correspond to references on the ground of the spatial environment within which it is possible to navigate.

By the term ‘load level of the terminal’, is meant information indicating the current load of the terminal with respect to its capacities, whatever they may be, software or hardware, such as for example its load relative to its storage capacities or also relative to its data processing capacities.

There is no limitation on the applications implemented on the terminal which can use the representation data received by the terminal. These applications can relate to any type of virtual navigation in a three-dimensional environment. In particular, it can be provided that the application using these representation data is an application for virtual navigation within the spatial environment considered. Such an application makes it possible to display on the screen three-dimensional images of a spatial environment in which the terminal user wishes to move. A virtual navigation service can thus be provided that offers different urban environments to the user in order to allow him to navigate virtually within these environments. Apart from a virtual navigation, this service can provide corresponding additional information such as for example indicating with respect to certain buildings of the town, references to professional services which can be consulted there. No limitation is placed on the type of additional information which can be associated with such a virtual navigation service in particular in an urban environment.

The application using the representation data received at the level of the terminal can also be a video game application for example. In fact, certain video games present one or more virtual characters which are developed in three-dimensional spatial environments represented on the terminal screen.

Whatever the application involved, the terminal screen displays a representation of a part of the spatial environment from a particular viewpoint. It is possible to move this viewpoint within the spatial environment represented on the terminal screen.

As a result of the provisions described above, it is possible to obtain a continuous transmission (streaming) of the representation data which, on the one hand, are relevant to the application implemented on the terminal and, on the other hand, do not overload the terminal beyond its capacities. This combination of a continuous transmission from the server, on the basis of a relevant request sent by the terminal, thus makes it possible to increase the virtual navigation performance, in particular with respect to the smoothness of the display and the navigation.

Indeed, in this case it is provided for a request to be made, in a single demand, for a continuous transmission of the useful representation data uniquely necessary to the application implemented on the terminal, in a quantity adapted both to the terminal load and to its capacities. The terminal implements a selection step of the parameters to be sent to the server in order to initiate such a continuous data transmission.

As the reception of the representation data progresses, it is convenient to manage a compromise between the storage capacities of the terminal and the quantities of representation data necessary for high-quality rendering of the spatial environment in which the terminal user wishes to navigate virtually.

Selection of a plurality of geographical areas is provided, on the basis of a criterion relating to a load level of the terminal. This step advantageously makes it possible to request representation data that are both relevant to the ability to offer the terminal user a virtual representation of the spatial environment and adapted to the capacities of the terminal.

Such a management of the transmission of the representation data allows a significant gain in time, in particular on initialization of the terminal application, i.e. when the terminal has not yet stored any representation data relative to the spatial environment in which it is desired to navigate virtually. Initialization of a continuous transmission of representation data can thus be performed in optimum fashion. In fact, on initialization of a virtual navigation type application, the load level of the terminal can be relatively low, in particular with respect to the storage capacity and with respect to the data processing capacity. As a result, a large number of geographical areas can advantageously be selected in step /a/. Then, the representation data corresponding to these geographical areas are continuously transmitted to the terminal. Thus, it is possible to accelerate the provision of the service at start-up by a factor of 10 with respect, in particular, to a transmission scheme based on a request sent for each geographical area relevant to the terminal user.

No limitation is placed on the term terminal in the context of the present invention. A terminal can in particular correspond to a computer or also a mobile telephone, and more generally to any electronic device capable of running a geographical information system application.

By the term ‘continuous transmission’ is meant a transmission according to which the representation data corresponding to the indications specified in the terminal request message are continuously transmitted to the latter, i.e. in a continuous flow of data.

A transmission protocol of the http/TCP (HyperText Transfer Protocol/Transmission Control Protocol) type can be used for this purpose. Use of such a protocol advantageously makes it possible to pass through security elements such as firewalls. It is also possible to use a protocol guaranteeing security such as a protocol of the SSL (Secure Sockets Layer) type.

Moreover, the use of such protocols makes it possible to carry out a transmission with a data loss rate that is practically zero.

This method allows a transmission suitable both for two-dimensional indexing, and for user behaviour which can be random, and thus non-linear, unlike transmissions of audiovisual content in streaming mode, for example.

When the representation data are of different types, it is possible in step /a/, to provide for selecting moreover at least one data type per selected geographical area.

Thus, it is possible either to request continuous transmission of representation data relating to one or more geographical areas, or to indicate, by geographical area, one or more data types. The data types, per geographical area, can be indicated by respective indices.

By the term ‘types of representation data’ is meant the different data types which can be used to represent the spatial environment considered, such as for example, buildings, street furniture, vegetation, advertising media, terrain, structure of the terrain, signage, businesses, etc.

Here a compromise can be established between the number of geographical areas selected and the number of data types selected, relative to the current load level of the terminal. This compromise can depend in particular on the type of application using these representation data. For example, if it is an application intended to show the providers of professional services present in the neighbourhood of the viewpoint from which the virtual spatial environment is viewed on the terminal screen, the data type relating to the buildings is selected while the display of other data types can be made optional. By thus sorting the data type to be transmitted as a priority, it is possible to reduce the quantity of representation data per geographical area. It is then possible to receive representation data for a greater number of geographical areas while remaining within the limits of the capacities of the terminal in terms of load.

In an embodiment of the present invention, step /a/ is moreover a function of a current load level of the communication network. Thus, the geographical areas, and in certain cases the data types selected, are advantageously a function of the state of the communication network used between the server and the terminal. It is therefore possible to adapt the representation data transmitted to the terminal both with respect to the load criteria appropriate for the terminal and also with respect to the load criteria of the network. A good-quality transmission between the server and the terminal can thus be guaranteed, as it is adapted to the communication network.

In an embodiment of the present invention, the request sent from the terminal to the server gives a current location and an orientation in the spatial environment; and the representation data received corresponds to the representation data adapted to the current location and to the orientation in the spatial environment.

In order to reduce the quantity of representation data to be transmitted and stored at terminal level, it is possible to implement a visibility algorithm, i.e. an algorithm which makes it possible to select representation data suitable for the location and the current orientation. In fact, it is possible to represent a spatial environment in a manner adapted to the location in relation to a viewpoint in the virtual world and to an orientation with respect to the neighbouring objects. The viewpoint corresponding to the virtual world displayed on the screen is situated at a greater or lesser distance from the surrounding objects. For example, when the virtual world of the navigation is an urban environment, the viewpoint can be situated at a greater or lesser distance from neighbouring buildings, these buildings being capable of being moreover higher or lower. Thus according to the location and orientation of the viewpoint in the virtual environment on the basis of which the virtual world is viewed on the screen, it is possible to view the neighbouring objects in greater or lesser detail.

It is then advantageous to provide several possible representations of these objects at different scales, i.e. with different levels of detail. Document EP 1 455 308 describes a multi-scale representation of this type, which makes it possible to transmit representation data adapted to the location and the relative orientation of the viewpoint. Implementation of such a teaching makes it possible to reduce appropriately the quantity of representation data transmitted from the server to the terminal, for a given number of geographical areas indicated in the terminal request. This feature therefore makes it possible to optimize the bandwidth used in the network, as well as the memory space occupied at the level of the terminal and therefore its load level with respect to the storage capacity of the terminal.

With the purpose of transmitting to the terminal only the representation data adapted both to its location within the virtual world and to the visibility level of the virtual world shown from this location, any visibility algorithm can be used which allows such representation data to be determined, such as that described moreover for example in document EP 1 934 946.

The continuous transmission protocol can advantageously be based on a protocol of the http/TCP type.

A second aspect of the present invention proposes a method for the management of data transmission in a geographical information system in which a spatial environment is represented by representation data with reference to geographical areas;

said geographical information system comprising a server and a terminal connected via a communication network;
the server storing the representation data according to geographical areas;
said method comprising the following steps carried out at the level of the server:

/a/ receiving a request indicating a plurality of geographical areas;

/b/ determining representation data according to said plurality of geographical areas; and

/c/ transmitting said representation data to the terminal according to a continuous transmission protocol.

In an embodiment of the present invention, the continuous transmission protocol is based on a protocol of the http/TCP type.

The request from the terminal to the server can indicate a current location and an orientation; and the representation data transmitted can then be selected according to the current location and orientation. In an embodiment of the present invention, different objects of the spatial environment are represented following a multi-level representation such as described in document EP 1 455 308. The server can then implement a method such as described in this document EP 1 455 308 in order to transmit only the representation data describing each object of the spatial environment with the level of detail corresponding to the location and orientation relative to the viewpoint.

A third aspect of the present invention proposes a terminal comprising means capable of implementing a management method according to the first aspect of the present invention.

A fourth aspect of the present invention proposes a server comprising means capable of implementing a method according to the second aspect of the present invention.

A fifth aspect of the present invention proposes a geographical information system in which a spatial environment is represented by representation data with reference to geographical areas; the system comprising a terminal according to the third aspect of the present invention and a server according to the fourth aspect of the present invention.

A sixth aspect of the present invention proposes a computer program comprising instructions for implementing a method according to the first aspect of the present invention when this program is executed by a processor.

A seventh aspect of the present invention proposes a computer program comprising instructions for implementing a method according to the second aspect of the present invention when this program is executed by a processor.

Other aspects, purposes and advantages of the invention will become apparent on reading the description of one of its embodiments.

The invention will also be better understood using the drawings, in which:

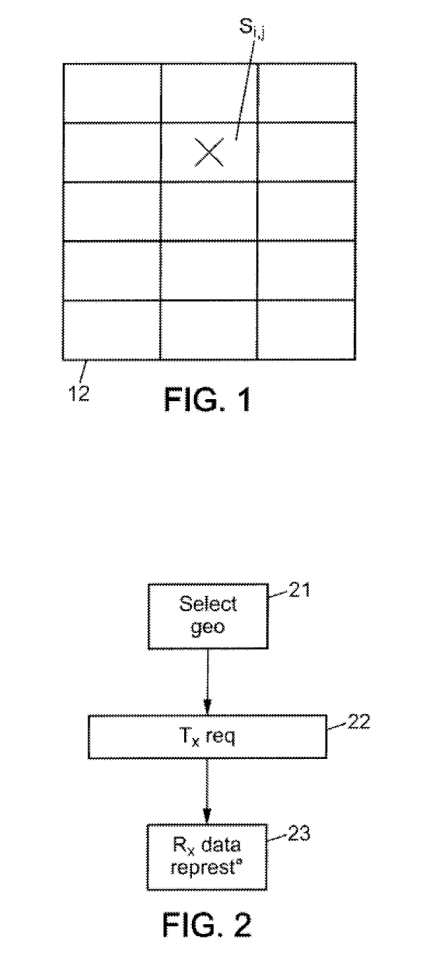

FIG. 1 shows geographical areas according to an embodiment of the present invention;

FIG. 2 shows the principal steps of a method according to an embodiment of the present invention;

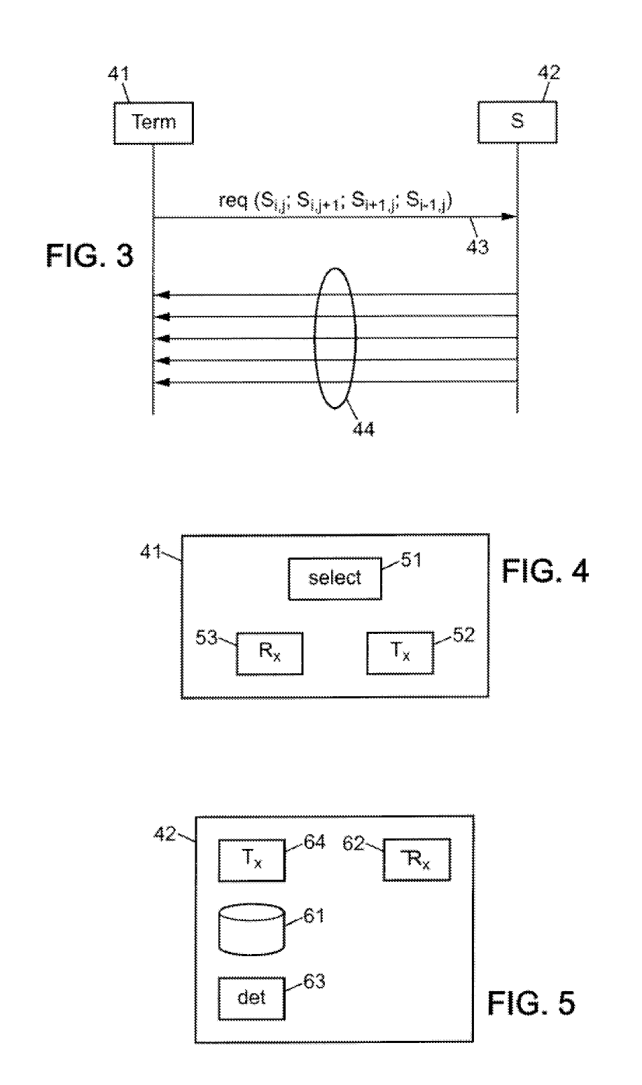

FIG. 3 shows an initialization of an application to be implemented on a terminal according to an embodiment of the present invention;

FIG. 4 shows a terminal according to an embodiment of the present invention; and

FIG. 5 shows a server according to an embodiment of the present invention.

FIG. 1 shows geographical areas according to an embodiment of the present invention. The spatial environment considered is projected onto the ground in a two-dimensional image 12. This image 12 is then broken down into a plurality of geographical areas S_{i,j}. When the current virtual location of the terminal user is situated in an area S_{i,j}, the terminal screen displays a virtual representation of what the user would be able to see if he were actually situated at this current location.

FIG. 2 shows the principal steps of a method according to an embodiment of the present invention.

In a geographical information system according to an embodiment, a spatial environment is represented by representation data with reference to geographical areas. A server and a terminal are connected via a communication network and the server stores the representation data according to geographical areas.

In a step 21, the terminal selects a plurality of geographical areas as a function of a criterion relating to a load level of the terminal.

In a step 22, the terminal sends a request to the server indicating this selected plurality of geographical areas. Then, in a step 23, the terminal receives representation data according to a continuous transmission protocol.

As a result of this selection step 21 taking account of the current load of the terminal, it is possible to optimize the continuous transmission of representation data from the server to the terminal.

FIG. 3 shows an initialization of an application to be implemented on a terminal according to an embodiment of the present invention. On initialization of the application, the user of the terminal wishes to be situated virtually in the geographical area S_{i,j}. Then, it monitors the load level. On initialization, as the load level is low both with respect to the storage capacity and also with respect to the data processing capacity, the terminal can select representation data relating to the geographical area S_{i,j}, as well as to the three neighbouring geographical areas S_{i,j+1}, S_{i+1,j} and S_{i-1,j}.

It sends a request 43 advantageously indicating in a grouped fashion the four geographical areas for which it requires to have representation data available for an upcoming navigation, and for which it has sufficient storage capacity.

In response to this request, the server continuously transmits the representation data 44 corresponding to the four geographical areas indicated in the request.

As a result of these arrangements, the terminal has available representation data which are not only useful for its upcoming navigation but moreover adapted to its capacities.

FIG. 4 shows a terminal according to an embodiment of the present invention. This terminal 41 comprises:
a selection unit 51 capable of selecting a plurality of geographical areas as a function of a criterion relating to a load level of the terminal;
a transmission unit 52 capable of sending a request to the server indicating the plurality of geographical areas selected; and
a receiving unit 53 capable of receiving representation data according to a continuous transmission protocol.

This terminal can comprise a unit for determining the load level of the terminal. The load level can relate to different aspects of the capacity of the terminal. Thus, for example, this load level can relate to the storage capacity of the terminal or also to the capacity of the terminal for processing the representation data. This load level can be expressed as a percentage of the maximum capacity of the terminal.

The capacity of the terminal with the regard to the number of images per second that the terminal is capable of processing, or also ‘frame rate’ can be used as a basis. It is thus possible to determine a load level with respect to a ‘frame rate’ value at a given moment, this value varying as a function of time.

It is also possible to refer to a RAM storage occupancy level in order to determine a load level. In fact, a load level greater than a certain threshold can advantageously indicate that the terminal is unable to manage further representation data without the need to store representation data in a disk memory, thus causing a consequent decrease in the ‘frame rate’.

FIG. 5 shows a server according to an embodiment of the present invention. This server 42 comprises:
a database 61 storing representation data according to geographical areas;
a receiving unit 62 capable of receiving a request indicating a plurality of geographical areas;
a determination unit 63 capable of determining representation data according to the plurality of geographical areas; and
a transmission unit 64 capable of transmitting the representation data to the terminal according to a continuous transmission protocol.

The receiving unit 62 of this server 42 is moreover capable of receiving a request indicating a current location within the virtual world and an orientation in this virtual world. In this context, the server can moreover comprise a unit for selecting representation data to be transmitted to the terminal according to the indicated location and orientation by applying a visibility algorithm.

What is claimed is:

1. A method for management of data transmission in a geographical information system in which a spatial environment is represented according to representation data with reference to geographical areas; said geographical information system comprising a server and a terminal connected via a communication network; the server storing the representation data according to the geographical areas; said method comprising the following, carried out at the level of the terminal:
selecting a plurality of geographical areas as a function of a criterion relating to a current load level of the terminal;
sending a request to the server indicating said plurality of geographical areas selected; and
receiving representation data according to a continuous transmission protocol.

2. The management method according to claim 1:
wherein the representation data are of different types; and
wherein at least one data type is chosen per geographical area selected from the plurality of geographical areas.

3. The management method according to claim 1, wherein selecting the plurality of geographical areas is also a function of a current load level of the communication network.

4. The management method according to claim 1:
wherein the request from the terminal to the server indicates a current location and an orientation in the spatial environment; and
wherein the representation data received correspond to the representation data adapted to the current location and to the orientation in the spatial environment.

5. A method for the management of data transmission in a geographical information system in which a spatial environment is represented according to representation data with reference to geographical areas; said geographical information system comprising a server and a terminal connected via a communication network; the server storing the representation data according to the geographical areas; said method comprising the following, carried out at the level of the server:
receiving, at the server, a request indicating a plurality of geographical areas;
determining representation data according to said plurality of geographical areas; and
transmitting said representation data to the terminal according to a continuous transmission protocol.

6. The data management method according to claim 5:
wherein the request from the terminal to the server indicates a current location and an orientation in the spatial environment; and
wherein the transmitted representation data are selected according to the current location and orientation in the spatial environment.

7. A terminal in a geographical information system in which a spatial environment is represented according to representation data with reference to geographical areas; said geographical information system comprising a server connected to the terminal via a communication network; the server storing the representation data according to the geographical areas; said terminal comprising:
a selection unit capable of selecting a plurality of geographical areas as a function of a criterion relating to a current load level of the terminal;
a transmission unit capable of sending a request to the server indicating said plurality of geographical areas selected; and
a receiving unit capable of receiving representation data according to a continuous transmission protocol.

8. A server in a geographical information system in which a spatial environment is represented according to representation data with reference to geographical areas; said geographical information system comprising a terminal connected to the server via a communication network; the server comprising:
a database adapted to store the representation data according to the geographical areas;
a receiving unit adapted to receive a request indicating a plurality of geographical areas;
a determination unit adapted to determine representation data according to said plurality of geographical areas; and
a transmission unit adapted to transmit said representation data to the terminal according to a continuous transmission protocol.

9. A geographical information system in which a spatial environment is represented according to representation data with reference to geographical areas; said system comprising a terminal according to claim 7 and a server according to claim 8.

10. A computer program comprising instructions for implementing a method for the management of the reception of data according to claim 1 when this program is executed by a processor.

11. A computer program comprising instructions for implementing a method for the management of data transmission according to claim 5 when this program is executed by a processor.
